(19) United States
(12) Patent Application Publication
(10) Pub. No.: US 2016/0092004 A1
(43) Pub. Date: Mar. 31, 2016

(54) CONDUCTIVE PATTERN AND ELECTRODE PATTERN OF SINGLE-LAYER CAPACITIVE TOUCHSCREEN

(71) Applicant: MITSUBISHI PAPER MILLS LIMITED, Tokyo (JP)

(72) Inventor: Takenobu YOSHIKI, Tokyo (JP)

(21) Appl. No.: 14/889,310

(22) PCT Filed: May 12, 2014
(86) PCT No.: PCT/JP2014/062632

§ 371 Date: Nov. 5, 2015

(30) Foreign Application Priority Data
May 16, 2013 (JP) 2013-103945

(51) Int. Cl. G06F 3/044; G06F 3/047

(52) U.S. Cl. CPC G06F 3/044; G06F 3/047; G06F 2203/04112; G06F 2203/04103

(57) ABSTRACT

Provided is a conductive pattern which has low visibility, has a high light transmittance, and hardly produces moire, and therefore is suitable as an optically transparent electrode for a capacitive touchscreen. The conductive pattern has a row of unit graphics formed of a conductive metal thin line or a metal thin line having line breaks, the unit graphic is selected from a concave hexagon and the congruent figures thereof, the concave hexagon has one inner angle greater than 180° (Angle A) and five inner angles each smaller than 180° with the proviso that the total of Angle A and the third angle from Angle A (Angle B) is 360°, the unit graphics adjoiningly line up in the row, and the row of the unit graphics extends in a direction of the bisector of an angle formed by the bisector of Angle A and the bisector of Angle B.

### TECHNICAL FIELD

The present invention relates to a conductive pattern of a conductive material mainly used for a touchscreen and an electrode pattern of a single-layer capacitive touchscreen.

### BACKGROUND ART

In electronic devices, such as PDAs (personal digital assistants), laptop computers, office automation equipment, medical equipment, and car navigation systems, touchscreens are widely used as their display screens that also serve as input means.

There are a variety of touch screens that utilize different position detection technologies, such as optical, ultrasonic, surface capacitive, projected capacitive, and resistive technologies. A resistive touchscreen has a configuration in which, as a touchsensor formed of an optically transparent electrode, an optically transparent conductive material and a glass plate with an optically transparent conductive layer are separated by spacers and face each other. A current is applied to the optically transparent conductive material and the voltage of the glass plate with an optically transparent conductive layer is measured. In contrast, a capacitive touchscreen has a basic configuration in which a touchsensor formed of an optically transparent electrode is an optically transparent conductive material having an optically transparent conductive layer provided on a base material and there are no movable parts. Capacitive touchscreens are used in various applications due to their high durability and high transmission. Further, a touchscreen utilizing projected capacitive technology allows simultaneous multipoint detection, and therefore is widely used for smartphones, tablet PCs, etc.

As an optically transparent conductive material used for touchscreens, those having an optically transparent conductive layer made of an ITO (indium tin oxide) film formed on a base material have been commonly used. However, since an ITO conductive film has high refractive index and high surface light reflectivity, the light transmittance of an optically transparent conductive material utilizing an ITO conductive film is unfavorably low. In addition, due to low flexibility, the ITO conductive film is prone to crack when bent, resulting in increased electric resistance of the optically transparent conductive material.

Known as an alternative to an optically transparent conductive material having an optically transparent conductive layer made of an ITO conductive film is an optically transparent conductive material using a mesh pattern of metal thin lines, as an optically transparent conductive layer on an optically transparent base material, in which metal pattern, for example, the line width, pitch, pattern shape, etc. are appropriately adjusted. This technology provides an optically transparent conductive material maintaining a high light transmittance end having a high conductivity (the optically transparent conductive layer formed of metal thin lines will hereinafter be written as a metal mesh film). Regarding the pattern of the metal mesh film, it is known that a repetition unit of any shape can be used. For example, in Patent Literature 1, a triangle, such as an equilateral triangle, an isosceles triangle, and a right triangle; a quadrangle, such as a square, a rectangle, a lozenge, a parallelogram, and a trapezoid; an resided polygon, such as a (regular) hexagon, a (regular) octagon, a (regular) dodecagon, and a (regular) icosagon; a circle; an ellipse; and a star, and a combinational pattern of two or more thereof are disclosed. In addition, a complicated electrode pattern can be drawn by using a pattern formed of a graphic unit having a line break as described in Patent Literature 2. Such a pattern has an advantage of being less visible (visibility is low) as well.

As a method for producing the above-mentioned metal mesh film, a semi-additive method for forming a metal mesh film, the method comprising making a thin catalyst layer on a base material, making a resist pattern on the catalyst layer, making a laminated metal layer in an opening of the resist by plating, and finally removing the resist layer and the base metal protected by the resist layer, is disclosed in, for example, Patent Literature 3 and Patent Literature 4. Also, in recent years, a method in which a silver halide diffusion transfer process and a silver halide photosensitive material are used has been known.

For example, Patent Literature 5, Patent Literature 6, and Patent Literature 7 disclose a technology for forming a metal mesh film by exposing a silver halide photosensitive material having a physical development nucleus layer and a silver halide emulsion layer in this order on a base material to give the material a desired pattern and subsequently bringing the material into a reaction with a soluble silver halide forming agent and a reducing agent in an alkaline fluid. The patterning by the method can reproduce uniform line width. In addition, the mesh pattern of the metal mesh film produced by this method is formed of developed silver (metal silver) substantially without any binder component, and due to the highest conductivity of silver among all metals, a thinner line with a higher conductivity can be achieved as compared with other methods. An additional advantage is that a metal mesh film obtained by this method has a higher flexibility, i.e. a longer flexing life as compared with an ITO conductive film. However, in cases where two layers OF the metal mesh film described in Patent Literature 1 to 7 are overlapped with each other, the respective mesh patterns interfere with each other, causing moire or other problems.

Generally, in a projected capacitive touchscreen, an optically transparent electrode having two metal mesh films each having a sensor part formed of a plurality of column electrodes (column electrodes consisting of metal mesh patterns) is used as a touch sensor. However, overlapping two metal mesh film layers results in a low light transmittance, leading to a dark touchscreen. To address these problems, Patent Literature 8, for example, proposes a single-layer capacitive touchscreen provided with, as an optically transparent electrode, a single optically transparent conductive layer having a special pattern for detection of a finger touch position, in cases where a metal mesh film is used as the optically transparent electrode in this method, there is no need to overlap two metal mesh films, and therefore the touchscreen has advantages of a high light transmittance and of being free from moire and other problems caused by the interference of the mesh patterns.

### CITATION LIST

### Patent Literature

Patent Literature 3: JP 2002-223095 A

Patent Literature 2: JP 2010-198799 A

Patent Literature 3: JP 2007-287994 A

Patent Literature 4: JP 2007-287953 A

Patent Literature 5: JP 2003-77350 A

Patent Literature 6: JP 2005-250169 A

Patent Literature 7: JP 2007-188655 A

Patent Literature 8: JP 2011-181057 A

### SUMMARY OF INVENTION

### Technical Problem

Typically, in a single-layer capacitive touchscreen, as in described in Patent Literature 8, an optically transparent area (for example, 301 in FIG. 3 of Patent Literature 8) has sensor parts (for example, 304 in FIG. 3 of Patent Literature 8) for sensing electrostatic capacitance and wiring parts (for example, 302 in FIG. 3 of Patent Literature 8) for transmitting changes in the capacitance sensed in the sensor parts as an electric signal to the outside. The wiring parts are usually each formed of a thin pattern so as to occupy as small area as possible, arranged together separately from the sensor parts, and each formed of a relatively long line. When a single-layer capacitive touchscreen is produced with use of a metal mesh film, such a wiring part formed of a long line is highly visible and conspicuous. To reduce the visibility of the wiring part, the wiring part is desirably formed of the same mesh pattern as that of the sensor part. However, as described later, by a conventionally known general method, it was difficult to produce the wiring part with a mesh pattern.

FIG. 1 illustrates conductive patterns of the wiring unit in the optically transparent area. in FIG. 1, (a-1) shows a wiring unit produced with use of an optically transparent conductive layer which is formed of not a metal mesh film but a solid pattern, for example, with use of an ITO conductive film. The wiring unit consists of wiring parts 11 and non-wiring parts 12. Specific examples where the wiring unit of (a-1) is formed of a common metal mesh film are shown in (a-2) and (a-3). In a metal mesh film, a current-carrying part (the wiring part 11 in (a-1)) generally consists of unit graphics (for example, lozenges) formed of metal thin lines and connected with each other. If nothing exists in a non-current-carrying part (the non-wiring part 12 in (a-1)), the wiring part is conspicuous, which poses a problem in the visibility. Therefore, in order to address the problem in the visibility, and to break the continuity between the wiring part and the non-wiring part or to avoid short-circuiting of two wiring parts, such a non-wiring part is generally provided with metal thin lines having line breaks. In (a-2) and (a-3) of FIG. 1, a dashed line represents a metal thin line having line breaks provided for solving the problem in the visibility, and a solid line represents a metal thin line not having line breaks.

(a-2) shows a wiring unit in which the wiring part 11 consists of a plurality of lozenges 13 formed of metal thin lines and the non-wiring part 12 consists of a plurality of lozenges 14 formed of metal thin lines having line breaks. In this example, the existence of the lozenge 14 solves the problem of visual recongizability of the wiring part 11. Meanwhile, for securing favorable conductivity, the line width of the metal thin lines of the wiring part 11 should not be too thin. As a result, the proportion of the area occupied by the metal thin lines per unit area becomes high, resulting in low light transmittance. If the size of the lozenge as the unit graphic is, for example, doubled, the light transmittance of the wiring unit becomes high. Such a wiring unit is shown in (a-3). In the metal mesh film shown in (a-3), the wiring part 11 and the non-wiring part 12 consist of unit graphics which are lozenges 15 formed of metal thin lines not having line breaks (solid lines) and metal thin lines having line breaks (dashed lines). Obviously, the light transmittance of the wiring unit of (a-3) is higher than that of (a-2). However, in (a-3), one wiring part 11 consists of only one metal thin line, and therefore has a problem of low production reliability. That is, if a trouble at the time of production etc. causes line breaks in the wiring part 11, the rate of good touch sensor production, i.e., so-called rate of yield, is decreased. In contrast, in the metal mesh film of (a-2), even if one metal thin line of the wiring part has a line break, unless the line break exists at a vertex where one lozenge 13 is in contact with the next lozenge the continuity is kept by the other metal thin line, and as a result, the production reliability is significantly higher as compared to that of the metal mesh film of (a-3).

The wiring part shown in (a-4) has metal thin lines 16 only as outlines of the solid pattern of the wiring part 11 of (a-1) for improved light transmittance. However, when such a pattern is used for a touchscreen, the metal pattern interferes with the black matrix of the liquid crystal overlaid on the touchscreen, causing moire.

FIG. 2 illustrates different conductive patterns of the wiring unit in the optically transparent area from those in FIG. 1. As with (a-1) of FIG. 1, (b-1) shows a wiring unit produced with use of an optically transparent conductive layer which is formed ct a solid pattern, for example, with use of an ITO conductive film. Also, specific examples where the wiring unit is formed of a common metal mesh film as in FIG. 1 are shown in (b-2) and (b-4).

The wiring part 11 of (b-2) consisting of lozenges 21 as in (a-2) of FIG. 1 has a problem of low light transmittance as (a-2). (b-3) has metal thin lines 22 and 23 only as outlines of the solid pattern of the wiring part 11 of (b-1). Unlike in (a-4) of FIG. 1, the metal thin lines 22 and 23 in the pattern of (b-3) are oblique to the vertical direction, and therefore the moire caused by the interference with the black matrix of the liquid crystal hardly occurs. On the other hand, such a pattern having metal thin lines arranged at narrow intervals exhibits characteristics of a diffraction grating. In this regard, the difference between the angle of the collective wiring 24 (the upper half of (b-3)) formed of metal thin lines 22 and the angle of the collective wiring 25 (the lower half of (b-3)) formed of metal thin lines 23 causes non-uniform interference. As a result, the problem of clearly recognizable wiring parts tends to arise. (b-4) shows a wiring unit produced by adding metal thin lines 26 and 27 having different angles from that of the metal thin line 22 or 23 to (b-3), which cannot solve the problem of visibility resulting from non-uniform interference as with the case of (b-3).

Therefore, an object of the present invention is to provide a conductive pattern which has low visibility, has a high light transmittance, and hardly produces moire, and therefore is suitable as an optically transparent electrode for a capacitive touchscreen, and to provide an electrode pattern of a single-layer capacitive touchscreen.

### Solution to Problem

The above object is basically achieved by a conductive pattern having a row of unit graphics formed of a conductive metal thin line or a metal thin line having line breaks, the unit graphic being selected from a concave hexagon and the congruent figures thereof, the concave hexagon having one inner angle greater than 180° (Angle A) and five inner angles each smaller than 180° with the proviso that the total of Angle A and the third angle from Angle A (Angle B) is 360°, the unit graphics adjoiningly lining up in the row, the row of the unit graphics extending in a direction of the bisector of an angle formed by the bisector of Angle A and the bisector of Angle B.

The unit graphic is preferably symmetrical to the diagonal line joining vertices at Angle A and Angle B.

Preferably, the unit graphic has a shape of the outline of a concave hexagon as a whole formed of a lozenge and two parallelograms joined to the lozenge, each of the parallelograms sharing one side with the lozenge, the two shared sides of the lozenge being adjacent to each other and forming one of the larger angles of the lozenge; more preferably, the smaller angles of the lozenge are 30 to 70°; and still more preferably, the parallelogram has longer sides adjacent to the shared side than the side of the lozenge.

Preferably, in the row of unit graphics, the unit graphics adjoiningly line up in such a manner that Angle A of one unit graphic and Angle B of an adjacent unit graphic are conjugate angles. More preferably, Angles A and B of all the unit graphics in the row are on the same straight line.

In the conductive pattern, preferably, a plurality of rows or unit graphics are arranged in parallel and in contact with each other. Alternatively, in the conductive pattern, a plurality of rows of unit graphics are preferably arranged in parallel at regular intervals, and more preferably a conductive metal thin line or a metal thin line having line breaks is arranged between such rows of unit graphics.

The above object is basically achieved by an electrode pattern using the above conductive pattern in a single-layer capacitive touchscreen. Preferably, the conductive pattern is used for the wiring part provided in the optically transparent area of the electrode pattern of a single-layer capacitive touchscreen.

### Advantageous of the Invention

The present invention can provide a conductive pattern which has low visibility, has a high light transmittance, and hardly produces moire, and therefore is suitable as an optically transparent electrode for a capacitive touchscreen, and can provide an electrode pattern of a single-layer capacitive touchscreen.

### BRIEF DESCRIPTION OF DRAWINGS

FIG. 1 illustrates conductive patterns of the wiring unit in the optically transparent area.

FIG. 2 which is a drawing different from FIG. 1, also illustrates conductive patterns of the wiring unit in the optically transparent area.

FIG. 3 illustrates unit graphics used for the conductive pattern of the present invention.

FIG. 4, which is a drawing different from FIG. 3, also illustrates unit graphics used for the conductive pattern of the present invention.

FIG. 5 illustrates rows of unit graphics, the rows being formed of unit graphics connected with each other.

FIG. 6 illustrates conductive patterns having a plurality of rows of unit graphics.

FIG. 7, which is a drawing different from FIG. 6, illustrates conductive patterns having a plurality of rows of unit graphics.

FIG. 8 illustrates exemplary line break patterns in which conductive streams of unit graphics are longitudinally obtained.

FIG. 9 illustrates exemplary line break patterns in which conductive streams of unit graphics are laterally obtained.

FIG. 10 illustrates exemplary line break patterns in which conductive streams of unit graphics are obliquely obtained.

FIG. 11 illustrates an example of the electrode pattern of a single-layer capacitive touchscreen.

FIG. 12 illustrates an exemplary application of the conductive pattern of the present invention to the electrode pattern of a single-layer capacitive touchscreen.

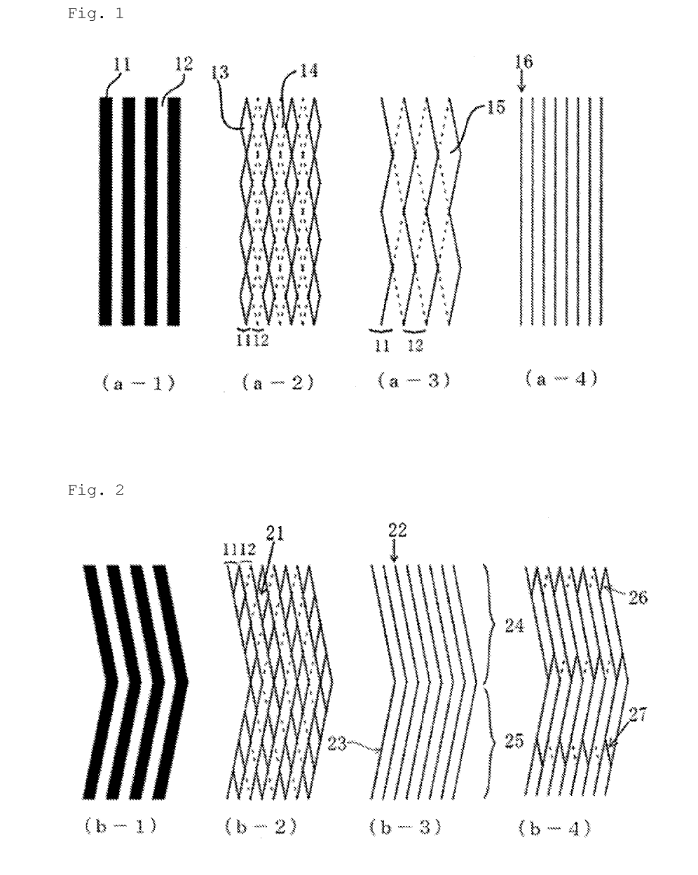

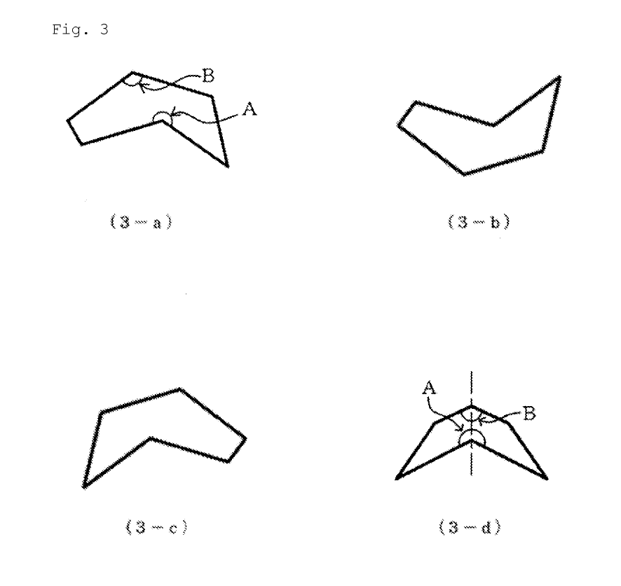

### DESCRIPTION OF EMBODIMENTS

Hereinafter, the present invention will be illustrated in detail with reference to drawings, but it is needless to say that the present invention is not limited thereto and various alterations and modifications may be made without departing from the technical scope of the invention.

FIG. 3 illustrates unit graphics used for the conductive pattern of the present invention, and lines (excluding lines for explanation, arrows, and symbols) represent metal thin lines. The unit graphic of the present invention is a graphic being selected from a concave hexagon and the congruent figures thereof, the concave hexagon having one inner angle greater than 180° (Angle A) and five inner angles each smaller than 180° with the proviso that the total of Angle A and the third angle from Angle A (Angle B) is 360°. In (3-a) of FIG. 3, Angle A is greater than 180° and the other five angles are smaller than 180°. When an angle adjacent to Angle A is counted as the first angle and the third angle from Angle A is named Angle B, the total of Angle A and Angle B is 360°. Congruent figures of a figure are those obtained by parallel displacement, rotational displacement (for example, (3-b) relative to (3-a)), or line-symmetrical displacement (for example, (3-c) relative to (3-a)). In the present invention, a row of unit graphics may be formed using only one kind of such congruent figures or using two or more kinds thereof in combination. Also, unless the effects of the present invention are impaired, non-congruent unit graphics, that is, unit graphics of different shapes may be used in combination. In addition, as shown in (3-d) for example, the unit graphic of the present invention is preferably symmetrical to the diagonal line joining vertices at Angle A and Angle B.

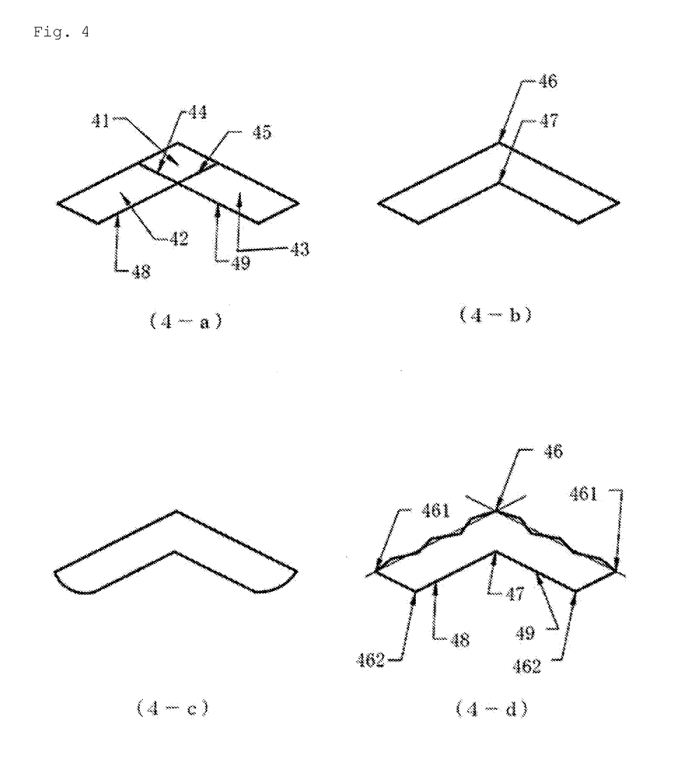

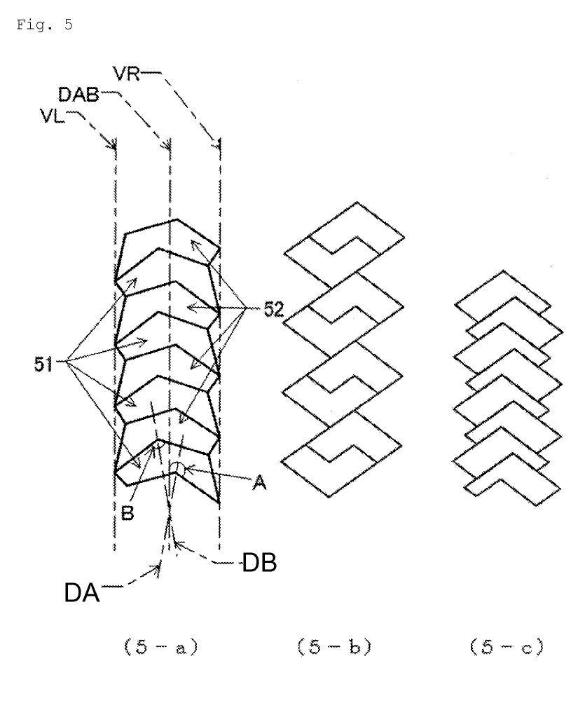

(4-a) of FIG. 4 is an expedient figure for illustrating a preferable unit graphic of the present invention. (4-a) is a figure which has the outline of a concave hexagon as a whole formed of a lozenge 41 and two parallelograms 42 and 43 joined to the lozenge, each of the parallelograms sharing one side with the lozenge, the two shared sides 44 and 45 of the lozenge being adjacent to each other and forming one of the larger angles of the lozenge. The figure obtained by removing the side 44 shared by the lozenge 41 and the parallelogram 42 and the side 45 shared by the lozenge 41 and parallelogram 43 from (4-a), that is, the shape of the outline of (4-a) is (4-b), which is the shape of a preferred unit graphic of the present invention. In the unit graphic shown in (4-b), the proportion of the area occupied by the metal thin lines is reduced by an amount corresponding to the sides 44 and 45 of the lozenge 41, which have been removed from the figure in (4-a). The parallelograms 42 and 43 may be lozenges. However, when the side 46 of the parallelogram 42 adjacent to the side 44 shared with the lozenge 41 is longer than the side 44 and the side 49 of the parallelogram 43 adjacent to the side 45 shared with the lozenge 41 is longer than the side 45, the proportion of the area occupied by the metal thin lines in the pattern is reduced. Therefore, use of this pattern further increases the light transmittance of the optically transparent electrode and makes it possible to produce a brighter touchscreen, and thus is more preferred. Although neither the side 44 nor the side 45 exists in the unit graphic shown in (4-b), the shape of (4-b) is based on the shape shown in (4-a). Therefore, for the purpose or clear explanation, hereinafter, preferred shapes of (4-b) will be explained with use of (4-a). Also, in the explanation below, a vertex of a unit graphic etc. means a bend point of the metal thin lines forming an angle of the figure (a point where a straight line is bent).

In the shape shown in (4-a), of the angles formed by two sides of the lozenge 41, the smaller angles are preferably 30 to 70°. The line width of the unit graphic (the line width of the metal thin line) is preferably 3 to 10 μm. The length of a side of the lozenge 41 depends on the shape of the pattern to be produced, but is preferably 50 to 800 μm. The angles formed by two sides of parallelogram 42 or 43 are preferably the same as those of the lozenge 41. The length of the side 48 or 49 is preferably 100 to 1200 μm. The parallelograms 42 and 43 are preferably symmetrical but may be different from each other as long as the lengths of the sides are within the above preferred ranges. The length of the longest aide of the unit graphic is preferably 150 to 2000 μm. In (4-b), the side are all straight lines. However, in the present invention, a variation of the concave hexagon in which a part of a side is an arc of a circle (4-c) or zigzagged (4-d) can be used. In this case, for example, the length of the longest side of the unit graphic having zigzag sides shown in (4-d) is the length of the straight line between the vertex 46 and the vertex 461 (not the zigzag line). Even if the side 48 or 49 has a zigzag shape, the length of the side 48 or 49 is the length of the straight line between the vertex 47 and the vertex 462. Similarly, the inner angles of the concave hexagon are angles formed by straight lines connecting the vertices. In the present invention, when the differences between the opposite angles in the above-described lozenge and parallelogram are within the range of ±5°, the shape is regarded as a lozenge or a parallelogram.

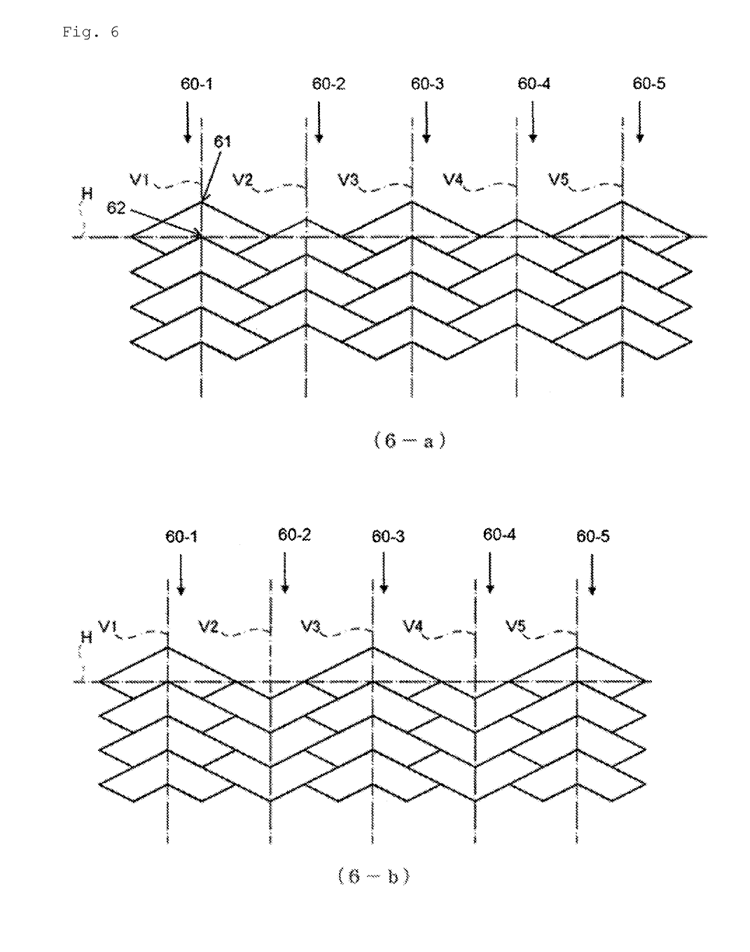

FIG. 5 illustrates rows of unit graphics of the present invention, the rows being formed of unit graphics connected with each other. In (5-a), a unit graphic 51 and its congruent unit graphic 52 alternately and adjoiningly line up to form a row of unit graphics. When the bisector of an angle formed by DA as the bisector of Angle A and DB as the bisector of Angle B in the unit graphic 51 is named DAB, the row of unit graphics extends in the direction along DAB. Here, “the row of unit graphics extends in the direction along DAB” means that the line VL connecting the leftmost and of the width of each unit graphic or the line VR connecting the rightmost end of the width of each unit graphic is parallel to DAB. In (5-a), only the DAB of the unit graphics 51 is shown, but the DAB of the unit graphics 52 exists in parallel to the DAB of the unit graphics 51 and is also parallel to the lines VL and VR.

In (5-a), Angle A of the unit graphic 51 and Angle B of the unit graphic 52 (or Angle B of the unit graphic 51 and Angle A of the unit graphic 52) are conjugate angles. Conjugate angles are two angles that share a vertex and two sides and sum to 360°. Thus, in the present invention, the row of unit graphics is preferably formed in such a manner that the Angle A of one unit graphic and Angle B of its adjacent unit graphic ere conjugate angles. (5-b) and (5-c) are other examples of the row of the unit graphics of the present invention.

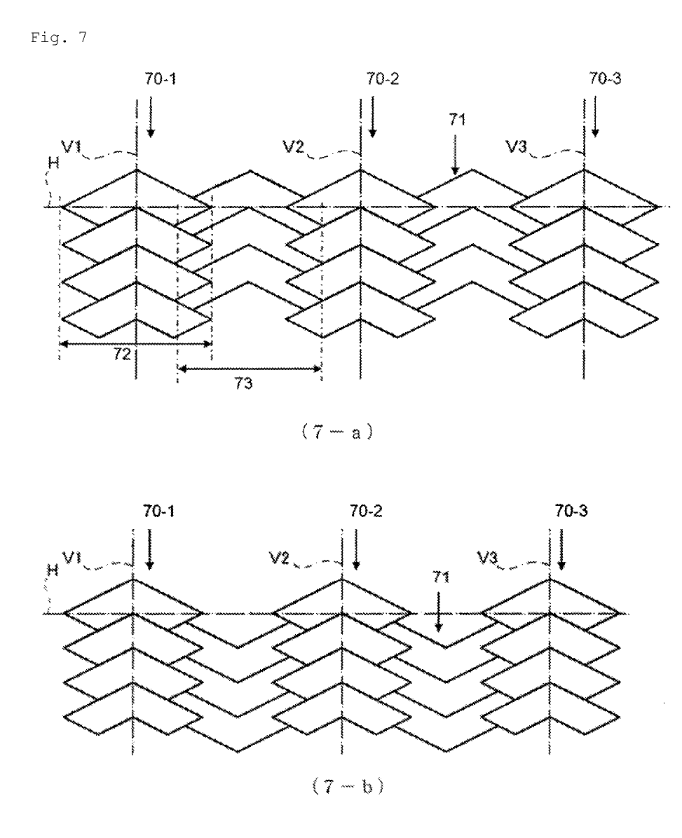

FIG. 6 illustrates preferred examples of the conductive pattern of the present invention having a plurality of rows of unit graphics, in (6-a), unit graphics adjoiningly line up in the direction of the straight line V1 through vertices 61 and 62 corresponding to vertices 46 and 47 shown in (4-b) of FIG. 4, and thus the row of unit graphics 60-1 is formed. That is, in FIG. 6, the bisector of Angle A, the bisector of Angle B, and the bisector of an angle formed by the two bisectors all accord with V1. Thus, in the present invention, it is preferred that Angles A and B of all the unit graphics included in the tow of unit graphics are on a straight line.

In the direction perpendicular to the line V1 (in the direction of the line H), in addition to the row of unit graphics 60-1, rows of unit graphics 60-2, 60-3, 60-4, and 60-5 are adjoiningly arranged in such a manner that straight lines V1, V2, V3, V4, and V5 as the bisectors of Angles A and B are parallel to each other. Thus, in the present invention, a plurality of rows of unit graphics are preferably arranged in parallel and in contact with each other. Here, “rows of unit graphics are in contact with each other” means that the metal thin lines located at the interface between two rows are shared by the two rows, and “rows of unit graphics are in parallel” means that the rows extend in the same direction. In cases where vertex 61 or 62 is arc-like as described above, the intersection of the extended lines of the straight line parts of the sides flanking the arc is regarded as an assumed vertex, and by connecting the assumed vertices, the straight line V1 etc., can be set. (6-b) is an example where the unit graphics forming rows adjacent to each other are congruent graphics.

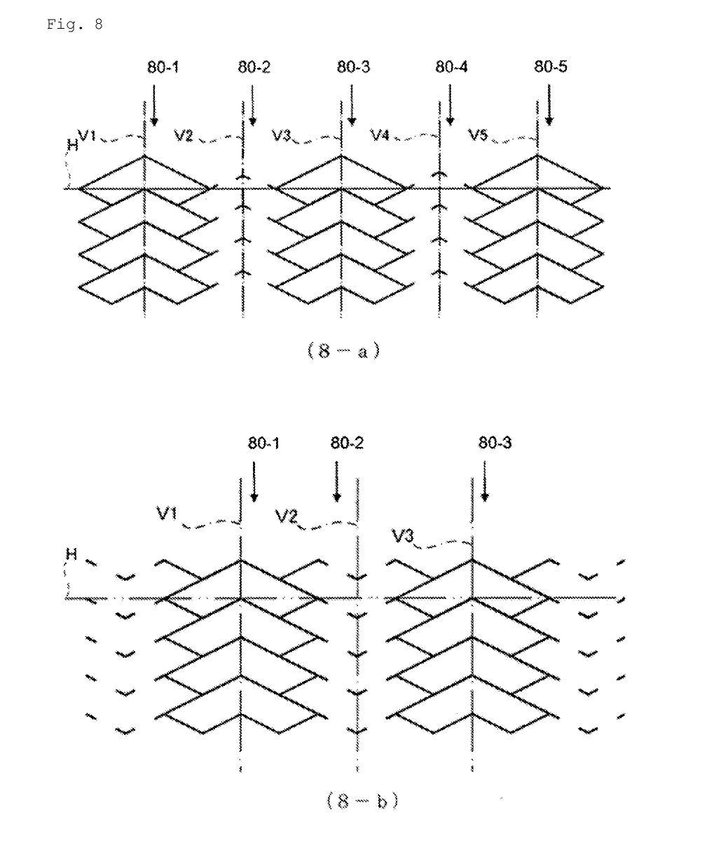

FIG. 7 illustrates preferred examples of the conductive pattern of the present invention where a plurality of rows of unit graphics are arranged in parallel at regular intervals, and conductive metal thin lines or metal thin lines having line breaks are arranged in the interspaces between such rows of unit graphics. In FIG. 7, in the direction perpendicular to the line V1 (in the direction of the line H), in addition to the row of unit graphics 70-1, rows of unit graphics 70-2 and 70-3 are arranged at regular intervals. Thus, in the present invention, a plurality of rows of unit graphics are preferably arranged in parallel with each other at regular Intervals. The distance between adjacent rows of unit graphics (the longest distance between adjacent rows of unit graphics approximately in the direction of H) 73 is preferably 0.8 to 1.2 times the width of the row of unit graphics (the longest width of the row of unit graphics approximately in the direction of H) 72 and more preferably 0.95 to 1.05 times. In FIG. 7, the rows of unit graphics 70-1, 70-2, and 70-3 are parallel to each other (straight lines V1 to V3 are parallel), which is the most preferred aspect. However, when the angle formed by the straight lines is within the range of ±10°, the objectives of the present invention can be achieved. Also, in the present invention, the plurality of rows of unit graphics are preferably arranged at regular intervals. Here, “at regular intervals” means that the distances between the rows of unit graphics 73 are within the range of ±10% and more preferably within the range of ±5%.

FIG. 7 shows that bent metal thin lines 71 are arranged in the interspaces between the rows of 70-1 to 70-3. The shape of metal thin line 71 is not limited, but preferably constitutes the same conjugate angles as those consisting of Angles A and B of the unit graphics forming the rows 70-1 to 70-3. In (7-a), the metal thin line 71 constitutes the conjugate angles in the same direction as those consisting of Angles A and B of the unit graphics forming the rows 70-1 to 70-3. In (7-b), the metal thin line 71 constitutes the conjugate angles in the opposite direction to those consisting of Angles A and B of the unit graphics forming the rows 70-1 to 70-3. The line width of metal thin lines 71 arranged in the interspaces between the rows of unit graphics is preferably the same as that of the aides forming the unit graphics.

In an electrode pattern of a single-layer capacitive touchscreen, in addition to a sensor part for sensing electrostatic capacitance and a wiring part for transmitting changes in the capacitance sensed in the sensor part as an electric signal to the outside, both of which are formed of conductive metal thin lines, a dummy part (non-conductive part) produced by patterning metal thin lines having line breaks can preferably be provided. The dummy part can contribute to the reduction in the visibility of the sensor part, the wiring part, or the like. The conductive pattern of the present invention can preferably be used for an electrode pattern comprising such a dummy part. The dummy part may have line breaks of the metal thin lines at vertezes in a mesh pattern or in the sides of the graphics forming the mesh pattern. The length of a line break is preferably 5 to 30 μm, and more preferably 7 to 20 μm. The line break may be provided perpendicularly or obliquely to the metal thin line forming the pattern.

FIG. 8 illustrates an example in which dummy parts comprising line breaks are provided so that conductive streams of unit graphics can longitudinally be obtained. in FIG. 8, a metal thin line having line breaks is represented by a dashed line, and a metal thin line not having line breaks (a conductive metal thin line) is represented by a solid line, schematically. In (8-a), as in (6-a) of FIG. 6, the rows of unit graphics 80-1, 80-2, 80-3, 80-4, and 80-5 are parallel to each other (straight lines V1, V2, V3, V4, and V5 are parallel). When 80-2 and 80-4 are dummy parts having line breaks, the visibility of the conductive pattern as the whole can be reduced while continuity can be obtained in each of the rows 80-1, 80-3, and 80-5. (8-b) is an example where a pattern similar to that of (6-b) of FIG. 6 is provided with dummy parts.

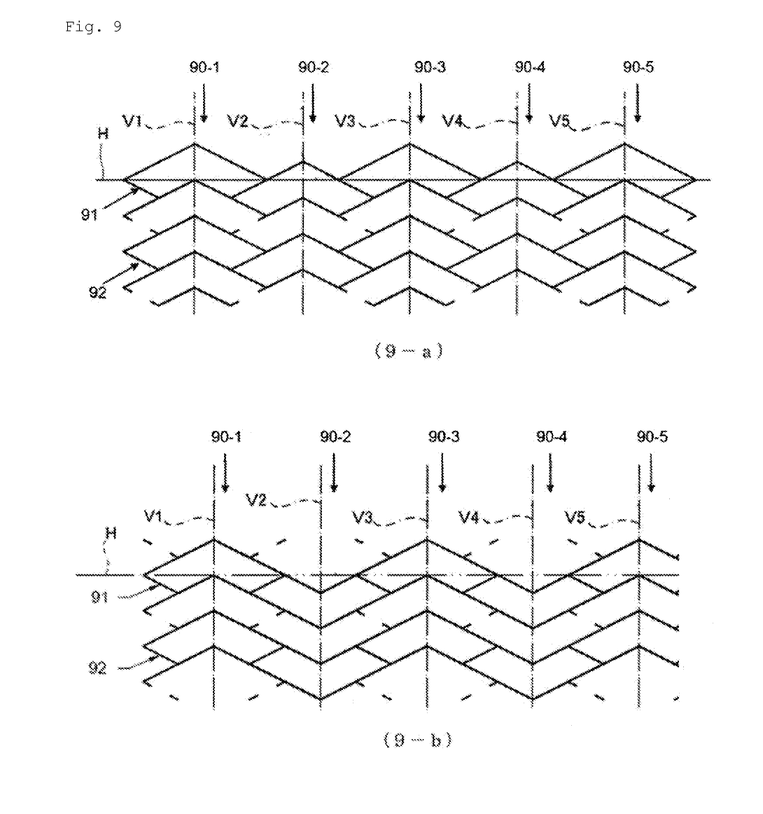

FIG. 9 illustrates an example in which dummy parts comprising line breaks are provided so that conductive streams of unit graphics can laterally be obtained. In FIG. 9 also, a metal thin line having line breaks is represented by a dashed line, and a metal thin line not having line breaks (a conductive metal thin line) is represented by a solid line, schematically. In (9-a), as in (6-a) of FIG. 6, the rows of unit graphics 90-1, 90-2, 90-3, 90-4, and 90-5 are parallel to each other (straight lines V1, V2, V3, V4, and V5 are parallel). This is an example in which dummy parts are provided in each of the rows of unit graphics 90-1, 50-2, 90-3, 90-4, and 90-5 in such a manner that conductive pacts 91 and 92 of the rows line up in the direction of the line H perpendicular to straight lines V1, V2, V3, V4, and V5. (9-b) is an example where a pattern similar to that of (6-b) of FIG. 6 is provided with dummy parts.

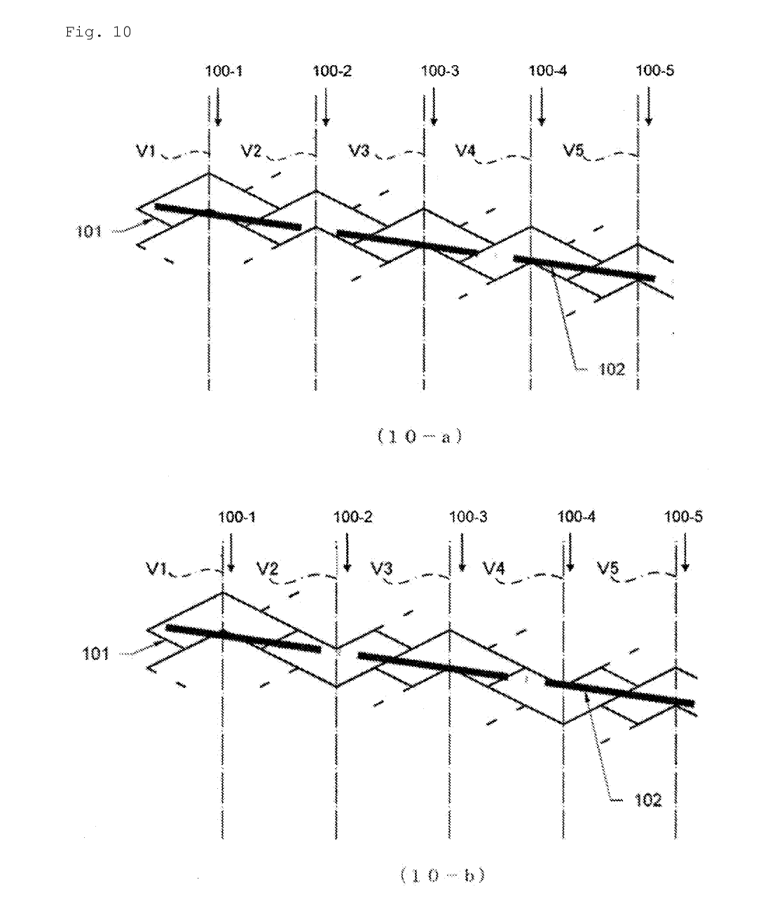

FIG. 10 illustrates an example in which dummy parts comprising line breaks are provided so that conductive streams of unit graphics can be obtained in a direction oblique to the vertical straight lines V1, V2, V3, V4, and V5. In FIG. 10 also, a metal thin line having line breaks is represented by a dashed line, and a metal thin line not having line breaks (a conductive metal thin line) is represented by a solid line, schematically. In (10-a), as in (6-a) of FIG. 6, the rows of unit graphics 100-1, 100-2, 100-3, 100-4, and 100-5 are parallel to each other (straight lines V1, V2, V3, V4, and V5 are parallel). This is an example in which dummy parts are provided in each of the rows of unit graphics 100-1, 100-2, 100-3, 100-4, and 100-5 in such a manner that conductive parts 101 of the rows line up in the direction oblique to the vertical straight lines V1, V2, V3, V4, and V5. (10-b) is an example where a pattern similar to that of (6-b) of FIG. 6 is provided with dummy parts. Conductive pacts 101 line up in the direction of the auxiliary line 102 (thick dashed line) shown for the purpose of clear explanation. Due to the conductive parts 101 provided in this way, the moire caused by the interference with the black matrix of the liquid crystal overlaid on the touchscreen can be avoided more effectively. Typically, the wiring part in the optically transparent area of a single-layer capacitive touchscreen is provided approximately in the same angle as that of the black matrix (generally formed of lines at 0° (horizontal direction in the figure) or 90° (vertical direction in the figure)) and tends to cause moire, but the conductive parts 101 (corresponding to the wiring part) shown in the pattern of FIG. 10 exist at an angle oblique to the vertical straight lines V1, V2, V3, V4, and V5, and therefore the angles of the wiring part and of the metal thin lines forming the wiring part are off the angle of the black matrix, less likely causing moire.

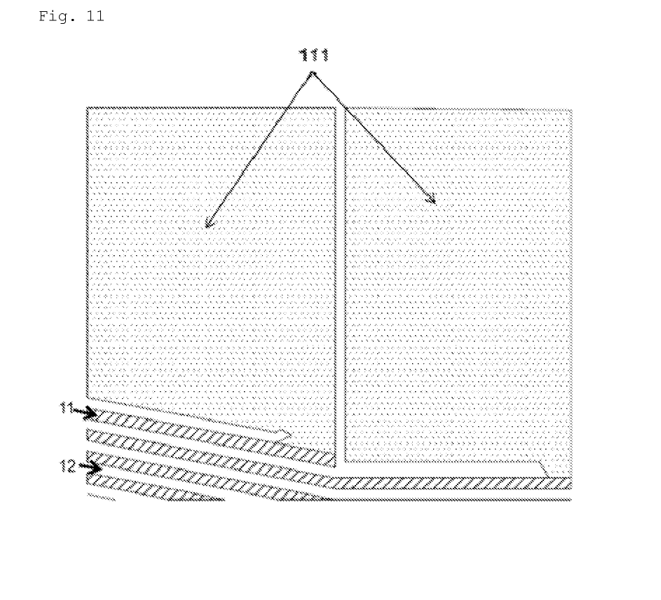

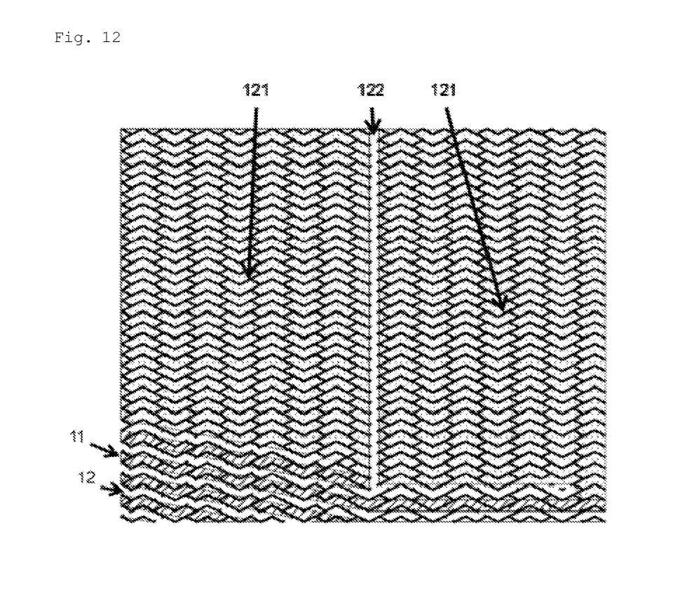

As described in full detail above, the conductive pattern of the present invention can be preferably used for the wiring part of a single-layer capacitive touchscreen, but also preferred is using the pattern for both the wiring part and the sensor part sensing electrostatic capacitance in the optically transparent area, which further lowers the visibility of the whole pattern. FIG. 11 illustrates an example of the electrode pattern of an ordinary single-layer capacitive touchscreen. As shown in FIG. 11, a single-layer capacitive touchscreen has, in an optically transparent area, sensor parts 111 (shown by halftone dots in FIG. 11) for sensing electrostatic capacitance and wiring parts 11 (shown as the shaded areas in FIG. 11) for transmitting changes in the capacitance sensed in the sensor parts 111 as an electric signal to the outside. In addition, to prevent short-circuiting of the wiring parts 11, a non-wiring part 12 is provided between two wiring parts 11 lying next to each other. In a single-layer capacitive touchscreen, the wiring part 11 and the sensor part 111 are generally made of the same material and therefore the boundary therebetween is not as clear as shown in FIG. 11. In the present invention, all the parts where the line width and the line direction are the same as those of the wiring part 11 are regarded as belonging to the wiring part 11.

FIG. 12 illustrates an exemplary application of the conductive pattern of the present invention to an electrode pattern of a single-layer capacitive touchscreen shown in FIG. 11. By placing, in the sensor part 121, metal thin lines of the conductive pattern of the present invention not having line breaks, a uniform conductivity can be obtained in the sensor part 121. Also, by placing, in a gap 122 between the sensor parts 121, metal thin lines of the conductive pattern of the present invention having line breaks, short-circuiting of the two sensor parts 121 can be prevented while the visibility is kept low. In regard to the wiring part, as described above, metal thin lines of the conductive pattern of the present invention not having line breaks are placed in the wiring part 11 and metal thin lines of the conductive pattern of the present invention having line breaks are placed in the non-wiring part 12, and thereby short-circuiting in the wiring part 11 and short-circuiting between two wiring parts 11 can be prevented while the visibility is kept low. By these means, the whole touchscreen surface is filled with a uniform pattern. As the result, the differences between the wiring part 11, the non-wiring part 12, the sensor part 121, and the gap 122 between the sensor parts 121 become extremely indistinguishable and, at the same time, the moire caused by the interference with the black matrix of the liquid crystal overlaid on the touchscreen can be avoided effectively.

### REFERENCE SIGNS LIST

11: Wiring part
12: Non-wiring part
13,14,15,21,41: Lozenge
16,22,23,26,27,71: Metal thin line
24,25: Collective wiring formed of metal thin lines
42,43: Parallelogram
44,45,48,49: Side
46,47,461,462,61,62: Vertex
51,52: Unit graphic
72: width of the row of unit graphics
73: Distance between the rows of unit graphics
60-1, 60-2, 60-3, 60-4, 60-5, 70-1, 70-2, 70-3, 80-1, 80-2, 80-3, 80-4, 80-5, 90-1, 90-2, 90-3, 90-4, 90-5, 100-1, 100-2, 100-3, 100-4, 100-5: Rows of unit graphics
91,92,101: Conductive part
102: Auxiliary line
111,121: Sensor part
122: Gap between sensor parts
A: Angle A
B: Angle B
DA: Bisector of angle A
DB: Bisector of angle B
DAB: Bisector of an angle formed by the bisector of Angle A and the bisector of Angle B
VL: Line connecting the leftmost end of the width of each unit graphic
VR: Line connecting the rightmost end of the width of each unit graphic
V1,V2,V3,V4, 5: Line showing the direction of the row of unit graphics
H: Line perpendicular to V1, V2, V3, V4, and V5

1. A conductive pattern having a row of unit graphics formed of a conductive metal thin line or a metal thin line having line breaks, the unit graphic being selected from a concave hexagon and the congruent figures thereof, the concave hexagon having one inner angle greater than 180° (Angle A) and five inner angles each smaller than 180° with the proviso that the total of Angle A and the third angle from Angle A (Angle B) is 360°, the unit graphics adjoiningly lining up in the row, the row of the unit graphics extending in a direction of the bisector of an angle formed by the bisector of Angle A and the bisector of Angle B.

2. The conductive pattern of claim 1, wherein the unit graphic is symmetrical to the diagonal line joining vertices at Angle A and Angle B.

3. The conductive pattern of claim 1, wherein the unit graphic has a shape of the outline of a concave hexagon as a whole formed of a lozenge and two parallelograms joined to the lozenge, each of the parallelograms sharing one side with the lozenge, the two shared sides of the lozenge being adjacent to each other and forming one of the larger angles of the lozenge.

4. The conductive pattern of claim 3, wherein the smaller angles of the lozenge are 30 to 70°.

5. The conductive pattern of claim 3, wherein the parallelogram has longer sides adjacent to the shared side than the side of the lozenge.

6. The conductive pattern of claim 1, wherein the unit graphics in the row adjoiningly line up in such a manner that Angle A of one unit graphic and Angle B of an adjacent unit graphic are conjugate angles.

7. The conductive pattern of claim 6, wherein Angles A and B of all the unit graphics in the row are on a straight line.

8. The conductive pattern of claim 1, wherein a plurality of rows of unit graphics are arranged in parallel and in contact with each other.

9. The conductive pattern of claim 1, wherein a plurality of rows of unit graphics are arranged in parallel at regular intervals.

10. The conductive pattern of claim 9, wherein a conductive metal thin line or a metal thin line having line breaks is arranged between the rows of unit graphics.

11. An electrode pattern of a single-layer capacitive touchscreen using the conductive pattern of claim 1.

12. The electrode pattern of claim 11 in a single-layer capacitive touchscreen, wherein the conductive pattern is used for a wiring part provided in an optically transparent area.
